(19) United States
(12) Patent Application Publication
(10) Pub. No.: US 2025/0385585 A1
(43) Pub. Date: Dec. 18, 2025

(54) Vibration Motor

(71) Applicant: AAC Microtech (Changzhou) Co., Ltd., Changzhou City (CN)

(72) Inventors: Peng Cai, Changzhou (CN); Junsheng Wang, Changzhou (CN); Jie Wu, Changzhou (CN); Fali Zhong, Changzhou (CN)

(21) Appl. No.: 19/006,322

(22) Filed: Dec. 31, 2024

Related U.S. Application Data
(63) Continuation of application No. PCT/CN2024/099721, filed on Jun. 18, 2024.

(51) Int. Cl. H02K 33/18

(52) U.S. Cl. CPC H02K 33/18

(57) ABSTRACT

The present invention provides a vibration motor, which has a housing with a space; a vibration unit including a magnet component arranged along a first direction, a driving unit including one coil unit; a guiding component supporting the vibration unit in the space; two auxiliary magnet components fixed to the housing, and a damping unit fixed to the housing and surrounding the adjacent ends of the two adjacent magnets. The magnets at the two ends are defined as the first magnets, and the two auxiliary magnet components are arranged correspondingly to the two first magnets; each auxiliary magnet component is magnetized along a second direction perpendicular to the first direction for forming a magnetic repulsion with the corresponding first magnet. The vibration unit of which can start or stop more quickly.

### TECHNICAL FIELD

This invention relates to a linear vibration motor used in portable electronic devices.

### BACKGROUND

With the development of science and technology and the progress of society, portable electronic products, such as mobile phones, handheld game consoles, navigation devices, or handheld multimedia entertainment devices, are widely used in people's daily lives. In some usage scenarios of these electronic products, such as incoming call alerts, message notifications, navigation prompts, and gaming console vibration feedback, they are generally implemented through vibration motors.

The vibrating motor of the related technology includes a vibration unit and a drive unit. The drive unit is fixed and does not move, and the vibration sense is generated by the vibration unit. In order to solve the problems of fatigue fracture of traditional elastic components, the related technology uses the force generated by the repulsion of like poles and the attraction of unlike poles between magnets to replace traditional springs. Due to the low damping of the horizontal linear vibration motor itself, foam damping is usually used to improve stability. However, foam damping is greatly affected by temperature and provides unstable damping, which seriously affects the vibration performance of the vibration motor.

Therefore, it is necessary to provide a vibration motor to solve the above problems.

### SUMMARY

One of the purposes of the present invention is to provide a vibration motor, the vibration unit of which can start or stop more quickly.

To achieve the above purpose, the present invention provides a vibration motor comprising: a housing with a space; a vibration unit accommodated in the space, including a magnet component arranged along a first direction, the magnet component having two magnets arranged along the first direction with opposite magnetization directions between adjacent magnets; a driving unit including at least one coil unit for driving the vibration unit along the first direction; a guiding component supporting the vibration unit in the space; two auxiliary magnet components fixed to the housing and respectively arranged at the two ends of the magnet component; and a damping unit fixed to the housing and surrounding the adjacent ends of the two adjacent magnets.

The magnets at the two ends are defined as the first magnets, and the two auxiliary magnet components are arranged correspondingly to the two first magnets; each auxiliary magnet component is magnetized along a second direction perpendicular to the first direction for forming a magnetic repulsion with the corresponding first magnet.

As an improvement, an amount of the magnets is two, the damping unit includes a damping ring fixed to the housing and surrounding adjacent end portions of the two magnets; the damping ring includes an outer surface fixedly connected to the housing and an inner surface opposite to the outer surface for connecting to the coil unit.

As an improvement, an amount of the magnets is three; the damping unit includes at least one damping ring fixed to the housing; at least one of the damping rings and the at least one the coil unit respectively surround adjacent ends of different adjacent magnets.

As an improvement, an amount of the magnets is four, magnets between the two first magnets are defined as a second magnet and a third magnet; the damping unit includes a damping ring fixed to the housing and surrounding the adjacent ends of the second magnet and the third magnet, the coil unit has two coil units respectively surrounding the adjacent ends of the first magnet and the second magnet, and the adjacent ends of the first magnet and the third magnet.

As an improvement, an amount of the magnets is four, the magnets arranged between the two first magnets are defined as a second magnet and a third magnet; the at least one coil unit surrounds the adjacent ends of the second magnet and the third magnet; the damping unit includes two damping rings and the two damping rings respectively surround the adjacent ends of the first magnet and the second magnet, and the adjacent ends of the first magnet and the third magnet.

As an improvement, the material of the damping unit includes at least one of iron, aluminum, silver, copper, and gold.

As an improvement, the magnet component further comprises a plurality of soft magnetic materials arranged at intervals along the first direction, an amount of the soft magnetic materials is one more than the amount of the magnets; and the magnets are respectively arranged between two adjacent soft magnetic materials.

As an improvement, the vibration unit further includes a mass block disposed at two ends of the magnet component; the soft magnetic materials includes a first soft magnetic material between the mas block and the first magnet, and a second soft magnetic material between two adjacent magnets; the coil unit and the damping unit locate opposed to the second soft magnetic material, and the auxiliary magnet component locates opposed to the first soft magnetic material.

As an improvement, the auxiliary magnet component includes a pair of auxiliary magnet pieces magnetized along the second direction and located on either side of the vibrating unit, forming a magnetic repulsion with the corresponding first magnet; or, the auxiliary magnet component includes two pairs of auxiliary magnet pieces magnetized along the second direction and located on either side of the vibrating unit, forming a magnetic repulsion with the corresponding first magnet; or the auxiliary magnet component is an annular magnet, where the second direction is the radial direction of the annular magnet, and the annular magnet forms a magnetic repulsion with the corresponding first magnet.

As an improvement, the vibration unit further includes a clamping plate with a cavity, the magnet component is fixed on the clamping plate and at least partially housed in the cavity; and the clamping plate is slidably connected to the guide component.

The new vibration motor of the invention comprises a housing with a space, a vibration unit accommodated in the space, a drive unit that drives the vibration unit to reciprocate along a first direction, and a guide component supporting the vibration unit. The vibration unit includes a magnet component arranged along the first direction, which consists of at least two magnets arranged along the first direction, each of which is magnetized along the first direction and the magnetization direction of adjacent magnets is opposite. The drive unit includes a coil unit that drives the vibration unit to reciprocate.

The vibration motor further includes two auxiliary magnet components fixed to the housing and respectively positioned at the two ends of the magnet component, with the magnet components arranged at the ends defined as the first magnet. The two auxiliary magnet components correspondingly correspond to the two first magnets, and each auxiliary magnet component is magnetized along a second direction perpendicular to the first direction to form a magnetic repulsion with the corresponding first magnet.

The vibration motor further includes a damping unit fixed to the housing and surrounding the adjacent ends of the adjacent magnets. The setting of the damping unit in the above structure allows the vibration unit in the vibration motor to start and stop more quickly, thereby improving the vibration effect.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a vibration motor in accordance with an exemplary embodiment of the present invention.

FIG. 2 is a partially exploded view of the vibration motor in FIG. 1.

FIG. 3 is a cross-sectional view of the vibrating motor with four magnets, taken along line A-A in FIG. 1.

FIG. 4 is a cross-sectional view of the vibrating motor with two magnets, taken along line A-A in FIG. 1.

### DETAILED DESCRIPTION OF THE EMBODIMENTS

The following will be taken in conjunction with the accompanying drawings of embodiments of the present invention, The technical scheme in the embodiment of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

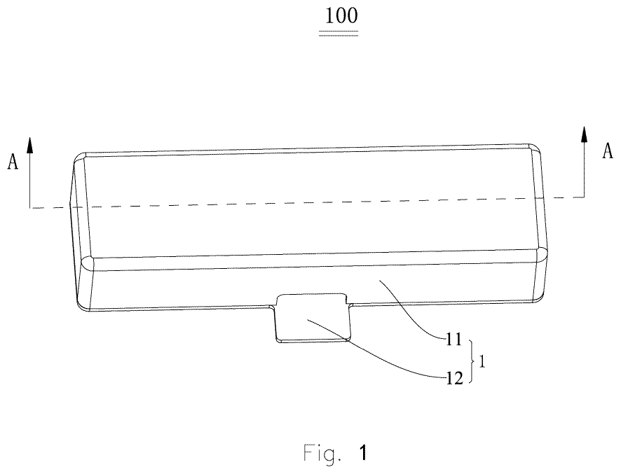

Please refer to FIGS. 1-3. A vibration motor 100 is provided in an embodiment of the present invention. The vibration motor comprises a housing 1 with a space 10, a vibration unit 2 accommodated in the space 10, a driving unit 3 that drives the vibration unit 2 to reciprocate along a first direction, and a guide component 4 supporting the vibration unit 2. The housing 1 includes an upper cover 11 and a lower cover 12 that covers the upper cover 11.

The vibration unit 2 comprises a magnet component 21 arranged along a first direction, the magnet component 21 comprises at least two magnets 211 arranged along the first direction, each magnet 211 is magnetized along the first direction and the magnetization direction of adjacent two magnets 211 is opposite, the drive unit 3 comprises a coil unit 31 for driving the vibration unit 2 to reciprocate, the vibration motor 100 further comprises two auxiliary magnet components 5 fixed to the housing 1 and respectively arranged at the two ends of the magnet component 21, defining the magnets 211 arranged at the two ends as the first magnet 2111, the two auxiliary magnet components 5 are correspondingly arranged with the two first magnets 2111, each auxiliary magnet component 5 is magnetized along a second direction perpendicular to the first direction and forms a magnetic repulsive force with the corresponding first magnet 2111, the vibration motor 100 further comprises a damper unit 6 fixed to the housing 1 and arranged around the adjacent ends of the adjacent two magnets 211.

Specifically, when the vibration unit 2 vibrates under the magnetic field of the coil unit 31 and the magnet component 21, the damping unit 6 cuts the magnetic lines of force, generates local eddy currents, thus producing a reverse electromotive force that hinders the vibration of the vibration unit 2. Therefore, an electromagnetic damping effect is generated, which can provide different damping forces according to the amplitude of vibration of the vibration unit 2. By setting the damping unit 6, the vibration unit 2 in the vibration motor 100 can start and stop more quickly, thereby improving the vibration effect.

In the preferred embodiment, the material of the damping unit 6 includes at least one of iron, aluminum, silver, copper, and gold. Alternatively, the material of the damping unit 6 can also be other highly conductive materials, without limitation here. The damping unit 6 using highly conductive metals has less temperature influence, thus providing a more stable damping effect.

In addition, since the coil unit 31 is the position with the largest change in electromagnetic field, when the damping unit 6 is located near the coil unit 31, a higher electromagnetic damping effect can be achieved. It should be noted that the arrangement of coil unit 31 and damping unit 6 can be adjusted according to the different numbers of magnet 211.

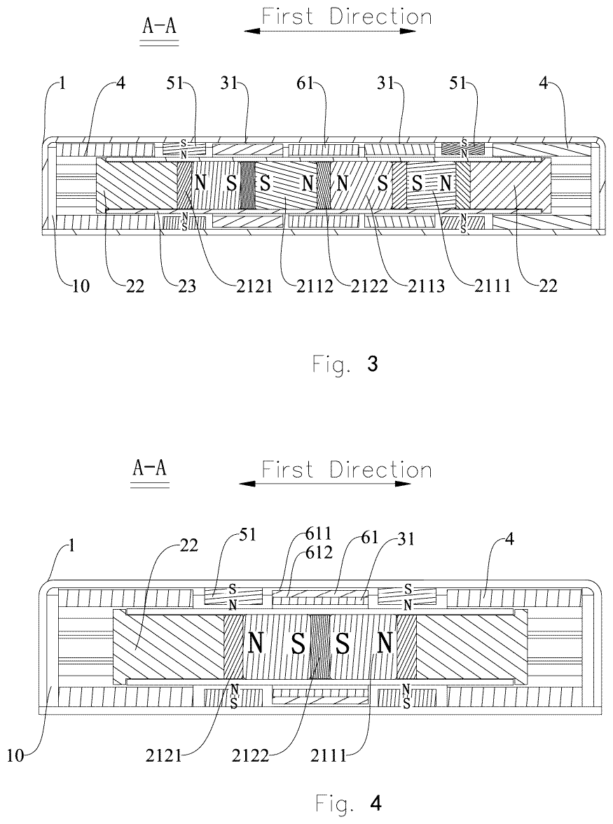

As shown in FIG. 4, the damping unit 6 of the magnet 211 is provided with two, comprising a damping ring 61 fixed to the housing 1 and surrounding the adjacent ends of the two first magnets 2111. The damping ring 61 includes an outer surface 611 fixedly connected to the housing 1 and an inner surface 612 opposite to the outer surface 611, and the coil unit 31 has one and the coil unit 31 is fixed to the inner surface 612.

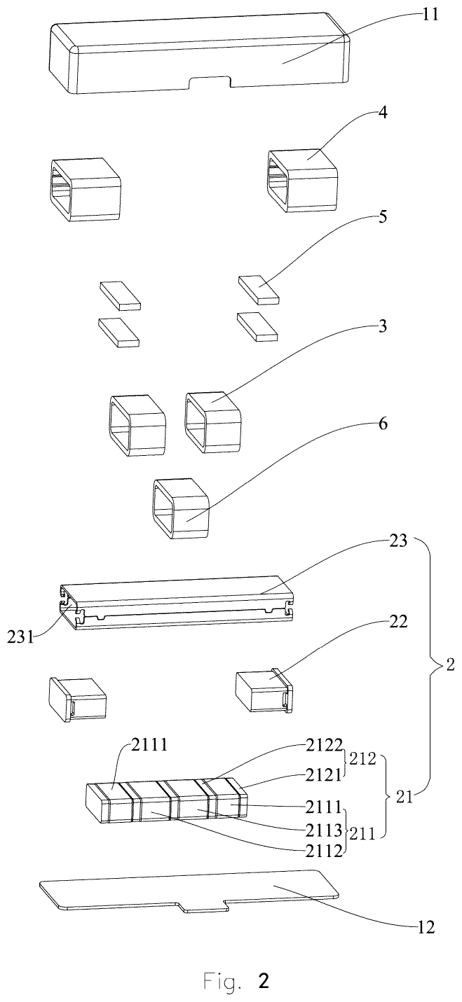

As shown in FIGS. 2-3, the magnet 211 is provided with four, defined as the second magnet 2112 and the third magnet 2113 arranged between the two first magnets 2111. The damping unit 6 includes a damping ring 61 fixed to the housing 1, and the damping ring 61 surrounds the adjacent ends of the second magnet 2112 and the third magnet 2113. The coil unit 31 has two coils, and each coil unit 31 surrounds the adjacent ends of the first magnet 2111 and the second magnet 2112, as well as the adjacent ends of the first magnet 2111 and the third magnet 2113. Optionally, the coil unit 31 has one coil surrounding the adjacent ends of the second magnet 2112 and the third magnet 2113, and the damping unit 6 includes two damping rings 61 surrounding the adjacent ends of the first magnet 2111 and the second magnet 2112, and the adjacent ends of the first magnet 2111 and the third magnet 2113.

As shown in FIGS. 2-4, the selected magnet component 21 also includes soft magnetic bodies 212 arranged at intervals along the first direction. The presence of the soft magnetic bodies 212 enhances the magnetic field, increasing the driving force of the vibration motor 100. The number of soft magnetic bodies 212 is one more than the number of magnets 211, and the magnets 211 are respectively located between adjacent two soft magnetic bodies 212.

The vibrating unit 2 also includes mass blocks 22 set at both ends of the magnet component 21. The soft magnetic material 212 includes a first soft magnetic material 2121 located between the mass blocks 22 and the auxiliary magnet component 5, and a second soft magnetic material 2122 sandwiched between two adjacent magnets 211. The coil unit 31 and the damping unit 6 are both spaced opposite the second soft magnetic material 2122, and the auxiliary magnet component 5 is spaced opposite the first soft magnetic material 2121, so as to maximize the utilization of the magnetic field.

As shown in FIGS. 2-3, in the present embodiment, each auxiliary magnet component 5 may also include a pair of auxiliary magnets 51 that are magnetized along a second direction relative to both sides of the vibrating unit 2, forming a magnetic repulsion with the corresponding first magnet 2111. It can be understood that the second direction is a series of directions perpendicular to the first direction. Alternatively, each auxiliary magnet component 5 includes two pairs of auxiliary magnets 51 magnetized along the second direction on both sides of the vibrating unit 2, forming a magnetic repulsion with the corresponding first magnet 2111. Alternatively, each auxiliary magnet component 5 can also be an annular magnet, with the second direction being the radial direction of the annular magnet, forming a magnetic repulsion with the corresponding first magnet 2111.

The vibration unit 2 also includes a clamping plate 23 with a cavity 231, the magnet component 21 is fixed on the clamping plate 23 and accommodated in the cavity 231, the clamping plate 23 is slidably connected to the guide component 4, and there is sliding friction between the clamping plate 23 and the guide component 4, thus protecting the magnet component 21 and avoiding damage to the magnet component 21 during movement. It should be noted that the guide component 4 can be a sliding shaft inserted in the vibration unit 2, or the guide component 4 can also be fixed on the housing 1 track, etc., without limitation here.

The setting of the damping unit 6 in the above structure can make the vibration unit 2 in the vibration motor 100 start and stop faster, thereby improving the vibration effect.

The foregoing is merely illustrative of embodiments of the present invention, and it should be noted that modifications may be made to those skilled in the art without departing from the spirit of the invention but are intended to be within the scope of the invention.

What is claimed is:

1. A vibration motor comprising:
a housing with a space;
a vibration unit accommodated in the space, including a magnet component arranged along a first direction, the magnet component having two magnets arranged along the first direction with opposite magnetization directions between adjacent magnets;
a driving unit including at least one coil unit for driving the vibration unit along the first direction;
a guiding component supporting the vibration unit in the space;
two auxiliary magnet components fixed to the housing and respectively arranged at the two ends of the magnet component; and
a damping unit fixed to the housing and surrounding the adjacent ends of the two adjacent magnets;
wherein
the magnets at the two ends are defined as the first magnets, and the two auxiliary magnet components are arranged correspondingly to the two first magnets; each auxiliary magnet component is magnetized along a second direction perpendicular to the first direction for forming a magnetic repulsion with the corresponding first magnet.

2. The vibration motor as described in claim 1, wherein an amount of the magnets is two, the damping unit includes a damping ring fixed to the housing and surrounding adjacent end portions of the two magnets; the damping ring includes an outer surface fixedly connected to the housing and an inner surface opposite to the outer surface for connecting to the coil unit.

3. The vibration motor as described in claim 1, wherein an amount of the magnets is three; the damping unit includes at least one damping ring fixed to the housing; at least one of the damping rings and the at least one the coil unit respectively surround adjacent ends of different adjacent magnets.

4. The vibration motor as described in claim 3, wherein an amount of the magnets is four, magnets between the two first magnets are defined as a second magnet and a third magnet; the damping unit includes a damping ring fixed to the housing and surrounding the adjacent ends of the second magnet and the third magnet, the coil unit has two coil units respectively surrounding the adjacent ends of the first magnet and the second magnet, and the adjacent ends of the first magnet and the third magnet.

5. The vibration motor as described in claim 3, wherein an amount of the magnets is four, the magnets arranged between the two first magnets are defined as a second magnet and a third magnet; the at least one coil unit surrounds the adjacent ends of the second magnet and the third magnet; the damping unit includes two damping rings and the two damping rings respectively surround the adjacent ends of the first magnet and the second magnet, and the adjacent ends of the first magnet and the third magnet.

6. The vibration motor as described in claim 1, wherein the material of the damping unit includes at least one of iron, aluminum, silver, copper, and gold.

7. The vibration motor as described in claim 1, wherein the magnet component further comprises a plurality of soft magnetic materials arranged at intervals along the first direction, an amount of the soft magnetic materials is one more than the amount of the magnets; and the magnets are respectively arranged between two adjacent soft magnetic materials.

8. The vibration motor as described in claim 7, wherein the vibration unit further includes a mass block disposed at two ends of the magnet component; the soft magnetic materials includes a first soft magnetic material between the mas block and the first magnet, and a second soft magnetic material between two adjacent magnets; the coil unit and the damping unit locate opposed to the second soft magnetic material, and the auxiliary magnet component locates opposed to the first soft magnetic material.

9. The vibration motor as described in claim 1, wherein the auxiliary magnet component includes a pair of auxiliary magnet pieces magnetized along the second direction and located on either side of the vibrating unit, forming a magnetic repulsion with the corresponding first magnet; or, the auxiliary magnet component includes two pairs of auxiliary magnet pieces magnetized along the second direction and located on either side of the vibrating unit, forming a magnetic repulsion with the corresponding first magnet; or the auxiliary magnet component is an annular magnet, where the second direction is the radial direction of the annular magnet, and the annular magnet forms a magnetic repulsion with the corresponding first magnet.

10. The vibration motor as described in claim 1, wherein the vibration unit further includes a clamping plate with a cavity, the magnet component is fixed on the clamping plate and at least partially housed in the cavity; and the clamping plate is slidably connected to the guide component.
